(19) United States
(12) Patent Application Publication
(10) Pub. No.: US 2025/0011592 A1
(43) Pub. Date: Jan. 9, 2025

(54) RECYCLED POLYMERIC COMPOSITION FOR COMPUTER CHASSIS

(71) Applicant: DELL PRODUCTS L.P., Round Rock, TX (US)

(72) Inventors: Nicholas Abbatiello, Round Rock, TX (US); Allison Ward, Northville, MI (US); XinHua Tian, Shanghai (CN)

(73) Assignee: DELL PRODUCTS L.P., Round Rock, TX (US)

(21) Appl. No.: 18/217,128

(22) Filed: Jun. 30, 2023

(51) Int. Cl. C08L 69/00; C08J 5/18; C08K 3/34; C08K 5/00; C08L 55/02; G06F 1/18

(52) U.S. Cl. CPC C08L 69/00; C08J 5/18; C08K 3/34; C08K 5/0066; C08L 55/02; G06F 1/181; C08J 2355/02; C08J 2369/00; C08K 2003/343; C08L 2201/02; C08L 2203/16; C08L 2203/30; C08L 2205/02; C08L 2205/035; C08L 2207/20

(57) ABSTRACT

Polymeric compositions, methods of making the compositions, and composites, such as computer chassis containing the compositions are described. The polymeric compositions can contain 10 wt. % to 70 wt. % of a post-consumer recycled information technology and telecommunications equipment (ITE) waste derived PC/ABS blend; 5 wt. % to 30 wt. % of a filler, wherein at least a portion of the fillers are obtained from a post-consumer recycled ITE waste; and 5 wt. % to 30 wt. % of a flame retardant obtained from a renewable source. In some instances, the polymeric compositions have a total recycled content of 50 wt. % to 90 wt. %.

### BACKGROUND OF THE INVENTION

### A. Field of the Invention

The invention generally relates to polymeric compositions with high recycle and renewable content while having sufficient mechanical strength for use in articles of manufacture. For example, the polymeric compositions can be used in the computer industry (e.g., chassis) and can allow for a more sustainable product (e.g., desktop, laptop, or mobile device computers).

### B. Description of Related Art

Polycarbonate/acrylonitrile butadiene styrenes (PC/ABS) are used in electronic and electrical devices such as computers, notebooks, laptops, cell phone, personal computers, e-books, and tablet personal computers, due to their light weight and good mechanical properties. However certain commonly used polycarbonates, such as Bisphenol A (BPA) polycarbonates, or PC/ABS blends are non-biodegradable and if not recycled can create various environmental problems, e.g., landfills, increased use of natural resources and energy, etc. Efforts have been made to increase recycle content of articles of manufacture that use polycarbonates or PC/ABS blends.

A traditional recycling method for plastics includes mechanical recycling. Mechanical recycling typically includes collecting used products or debris having the target polymer (e.g., polycarbonate-based plastics), optionally washing the used products or debris, melting the used products or debris into a raw material having the target polymer, and reusing the raw material to produce new articles of manufacture. However, the mechanical properties (e.g., tensile strength, tensile modulus, etc.) of recycled plastics (e.g., polycarbonates) can degrade as compared to virgin polymers. The degradation can be caused by the mechanical recycling process (e.g., input of energy during the melting process can lead to polymer chain scissions and lead to weaker polymers) and/or from contaminants. Thus, mechanical properties of an article of manufacture can degrade (e.g., reduction in ductility) with increasing amounts of mechanically recycled polymer. This can significantly limit the amount of recycled material that can be used in articles of manufacture such as various parts of electronic and electrical devices.

A typical solution to counteract the reduced mechanical properties of mechanically recycled polymer is the use of additives and introduction of other materials into the polymer composition. However, this solution can increase costs, can reduce sustainability, and/or can introduce caustic or environmentally unfriendly materials to the polymer composition.

### SUMMARY OF THE INVENTION

A solution to at least some of the aforementioned problems is disclosed herein. In one aspect, the solution can include combining a mixture of post-consumer recycled information technology and telecommunications equipment (ITE) waste derived polycarbonate/acrylonitrile butadiene styrene (PC/ABS) blend with other mechanically recycled non-ITE derived post-consumer recycled resin. In some aspects, other components are also included, such as renewable materials that can include flame retardants and PC from a renewable source. This may result in an article of manufacture (e.g., chassis for desktops, laptops, or mobile devices) that has a high overall content of recycled material without detrimentally compromising the mechanical strength of the resulting article of manufacture. In one aspect, it was found that a composition containing particular amounts of post-consumer recycled ITE waste derived PC/ABS blend, non-ITE derived post-consumer recycled resin, fillers, and/or flame retardants can have excellent mechanical properties and high recycle content. Therefore, articles of manufacture made from such compositions can be more sustainable and/or less caustic to the environment.

One aspect of the present invention is directed to a polymeric resin composition. The polymeric composition can contain a post-consumer recycled ITE waste derived PC/ABS blend, a filler, a flame retardant, and optionally a non-ITE derived post-consumer recycled resin, a PC/ABS virgin blend, and/or polycarbonate (PC) resin derived from a renewable source. In certain aspects, the polymeric composition may contain 10 wt. % to 70 wt. % of the post-consumer recycled information technology and telecommunications equipment (ITE) waste derived PC/ABS blend, 5 wt. % to 30 wt. % of the filler, and 5 wt. % to 30 wt. % of the flame retardant. The post-consumer recycled ITE waste derived PC/ABS blend may contain, at least in part, mechanically recycled PC/ABS from post-consumer waste. In certain aspects, the post-consumer recycled ITE waste derived PC/ABS blend may comprise additives. In some aspects, the polymeric composition may include at least any one of, at most any one of, equal to any one of, or between any two of 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, or 75 wt. % of post-consumer recycled ITE waste derived PC/ABS content. In some aspects, the polymeric composition may include at least any one of, at most any one of, equal to any one of, or between any two of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34 or 35 wt. % of the filler content. In some aspects, the polymeric composition may include at least any one of, at most any one of, equal to any one of, or between any two of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34 or 35 wt. % of the flame retardant content.

In some aspects, the polymeric composition may contain 0 wt. % to 80 wt. %, such as 45 wt. % to 55 wt. %, of the non-ITE derived post-consumer recycled resin. In some aspects, the polymeric composition may include at least any one of, at most any one of, equal to any one of, or between any two of 40, 41, 42, 43, 44, 45, 46, 47, 48, 49, 50, 51, 52, 53, 54, 56, 57, 58, 59, 60, 61, 62, 63, 64, 65, 66, 67, 68, 69, 70, 71, 72, 73, 74, or 75 wt. % of the non-ITE derived post-consumer recycled resin. In some aspects, the non-ITE derived post-consumer recycled resin can be originated from mechanically recycled plastics. In some aspects, the non-ITE derived post-consumer recycled resin can be originated from mechanically recycled plastic bottles and/or plastic containers. In some aspects, the polymeric composition may exclude a non-ITE derived post-consumer recycled resin. In some aspects, the polymeric composition may contain 2 wt. % to 5 wt. % of the PC/ABS virgin blend. In some aspects, the polymeric composition may include at least any one of, at most any one of, equal to any one of, or between any two of 1, 2, 3, 4, 5, 6, 7, 8, 9, 10 wt. % of the PC/ABS virgin blend. In some aspects, the PC/ABS virgin blend is derived from a renewable source. In some aspects, the polymeric composition may exclude a polycarbonate (PC) resin derived from a renewable source. In some aspects, the polymeric composition may contain 0 wt. % to 50 wt. % of the polycarbonate (PC) resin derived from a renewable source. In some aspects, the polymeric composition may include at least any one of, at most any one of, equal to any one of, or between any two of 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55 wt. % of the polycarbonate (PC) resin derived from a renewable source. In some aspects, the polymeric composition may exclude a polycarbonate (PC) resin derived from a renewable source. In certain aspects, the polymeric composition may contain 15 wt. % to 25 wt. % of the post-consumer recycled ITE waste derived PC/ABS blend, 45 wt. % to 55 wt. % of non-ITE derived post-consumer recycled resin, 20 wt. % to 30 wt. % of the combination of flame retardant and filler, and 2 wt. % to 5 wt. % of PC/ABS virgin blend or any concentration or range therein.

In some aspects, post-consumer recycled ITE waste derived PC/ABS blend may have a recycle content of 80 wt. % to 100 wt. %, or 90 wt. % to 100 wt. %, or 95 wt. % to 100 wt. %, or 98 wt. % to 100 wt. %, or 99 wt. % to 100 wt. %, or about 100 wt. %. In some aspects, the polymeric composition includes no more than 55 wt. % of the post-consumer recycled resin that is non ITE-derived. The renewably sourced polycarbonate and/or polycarbonate/acrylonitrile butadiene styrene (PC/ABS) virgin blend can be produced, at least in part, from a renewable feedstock. The renewable feed stock can be tall oil, sugar, castor beans and/or CO₂, such as waste CO₂. In some particular aspects, the renewable feed stock can be tall oil derived from wood pulp. Renewably sourced polycarbonate and/or polycarbonate/acrylonitrile butadiene styrene (PC/ABS) virgin blend can include carbon atoms from renewable feed stock. In some aspects, the renewably sourced polycarbonate can be no more than 50 wt. % of the PC resin derived from a renewable source. In some aspects, the renewably sourced polycarbonate/acrylonitrile butadiene styrene (PC/ABS) can be no more than 50 wt. % of the polycarbonate/acrylonitrile butadiene styrene (PC/ABS) virgin blend derived from a renewable source. In some aspects, at least a portion of the carbons in the renewably sourced polycarbonate and/or polycarbonate/acrylonitrile butadiene styrene (PC/ABS) virgin blend can be derived from the renewable feed stock. In some aspects, at least 70%, or at least 75%, or at least 80%, or at least 85%, or at least 90%, or at least 95%, or 100% of the carbons in the renewably sourced polycarbonate and/or polycarbonate/acrylonitrile butadiene styrene (PC/ABS) virgin blend can be derived from the renewable feed stock. In some aspects, at least a portion of the oxygens and/or hydrogens in the renewably sourced polycarbonate and/or polycarbonate/acrylonitrile butadiene styrene (PC/ABS) virgin blend can be obtained from the renewable feed stock. In some aspects, at least a portion of the carbons, oxygens, and/or hydrogens in the renewably sourced polycarbonate and/or polycarbonate/acrylonitrile butadiene styrene (PC/ABS) virgin blend can be obtained from non-renewable source(s).

In some aspects, the polymeric resin composition can contain a polycarbonate polymer and/or polycarbonate/acrylonitrile butadiene styrene (PC/ABS), that is a non-recycled polymer (e.g. virgin polycarbonate and/or virgin polycarbonate/acrylonitrile butadiene styrene (PC/ABS)) and is obtained from a non-renewable source. In some aspects, the polymeric resin composition can contain less than 5 wt. %, or less than 4 wt. %, or less than 3 wt. %, or less than 2 wt. %, or less than 1 wt. %, or less than 0.5 wt. %, or is free of, or essentially free of polycarbonate and/or polycarbonate/acrylonitrile butadiene styrene (PC/ABS) that is a non-recycled and non-renewable polycarbonate.

At least a portion of the fillers can be obtained from recycling ITE-derived post-consumer/post-industrial waste. In some aspects, the fillers may have a recycle content of 0 wt. % to 100 wt. %, or any concentration or range therein. In some aspects, the fillers may have a recycle content of at least any one of, at most any one of, equal to any one of, or between any two of 0, 5, 10, 15, 20, 25, 30, 35, 40, 45, 50, 55, 60, 65, 70, 75, 80, 85, 90, 95, or 100 wt. %. In some aspects, fillers can be talc, glass, mineral, carbon, or a combination thereof. In some aspects, the flame retardant can be obtained, at least in part, from a renewable source. In some aspects, the renewable content of the flame retardant can be 0 wt. % to 100 wt. %, or any concentration or range therein. In some aspects, the flame retardant may have a recycle content of at least any one of, at most any one of, equal to any one of, or between any two of 0, 5, 10, 15, 20, 25, 30, 35, 40, 45, 50, 55, 60, 65, 70, 75, 80, 85, 90, 95, or 100 wt. %. In some aspects, the flame retardant can be a non-halogenated flame retardant. In some aspects, the flame retardant can be a non-halogenated phosphorus containing flame retardant obtained from bio based chemicals. In some aspects, the flame retardant can be bisphenol-A-diphosphate obtained from bio based chemicals. In some aspects, the polymeric composition can further contain one or more additives. In some aspects, the additives may include pigments, plasticizers, antioxidants, UV-stabilizers, heat stabilizers, dye enhancing agents, lubricant, mold release agents, crystal nucleating agents, fluidability-improving agents, antistatic agents, compatibilizer, or anti-drip agents, or any combinations thereof. In certain aspects, the one or more additives can be pigments and plasticizers.

In certain aspects, the polymeric composition of the present invention can have any one of, any combination of, or all of the following properties: a tensile modulus equal to or greater than 3800 MPa, or 3800 MPa to 4200 MPa, or 3800 MPa to 4400 MPa, or 3800 MPa to 4600 MPa, or 4000 MPa to 4600 MPa at 23° C., as measured in accordance with ASTM D638; a tensile strength at break equal to or greater than 45 MPa, or 45 MPa to 60 MPa, or 45 MPa to 65 MPa, or 45 MPa to 70 MPa, or 50 MPa to 65 MPa, or 50 MPa to 70 MPa, or 55 MPa to 65 MPa, or 55 MPa to 70 MPa at 23° C., as measured in accordance with ASTM D638; a tensile elongation at break ≥8%, or ≥8.2%, or ≥8.4%, or ≥8.5%, or ≥7.9%, or ≥7.8%, or 7.8% to 9%, or 7.8% to 10%, or 7.8% to 11%, or 7.8% to 15%, or 7.8% to 8.5%, or 8% to 9%, or 8% to 10%, or 8% to 11%, or 8% to 15%, or 8% to 8.5% at 23° C., as measured in accordance with ASTM D638; and a Notched Izod Impact strength greater than 4 kJ/m², or greater than 4.2 kJ/m², or greater than 4.4 kJ/m², or greater than 4.5 kJ/m², or greater than 5 KJ/m², or greater than 5.5 KJ/m², or greater than 6 kJ/m², or greater than 6.5 kJ/m², or greater than 7 kJ/m², or greater than 7.5 kJ/m², or 4.1 kJ/m² to 10 KJ/m², or 4.1 kJ/m² to 9 KJ/m², or 4.1 kJ/m² to 8 KJ/m², or 4.1 kJ/m² to 7 KJ/m², or 4.1 kJ/m² to 6 KJ/m², or 4.1 kJ/m² to 7 KJ/m², or 4.1 kJ/m² to 6 kJ/m², or 4.1 kJ/m² to 5 KJ/m², or 4.1 kJ/m² to 4.5 kJ/m², or 4.1 kJ/m² to greater than 10 KJ/m², or 4.1 kJ/m² to 11 kJ/m², or 4.1 kJ/m² to 12 kJ/m², or 5 kJ/m² to 10 KJ/m², or 5 KJ/m² to 9 KJ/m², or 5 KJ/m² to 8 kJ/m², or 5 kJ/m² to 7 KJ/m², or 5 kJ/m² to 6 KJ/m², or 5 KJ/m² to 7 KJ/m², or 5 kJ/m² to 6 KJ/m², or 5 KJ/m² to 5 KJ/m², or 5 kJ/m² to 4.5 KJ/m², or 5 kJ/m² to greater than 10 kJ/m², or 5 kJ/m² to 11 kJ/m², or 5 kJ/m² to 12 kJ/m², at 23° C., as measured in accordance with ASTM D256.

In some aspects, the composition can be comprised in a film, layer, or a sheet. In some aspects, the polymeric composition can be a extrusion molded, a blow-molded, an injection-molded, a rotational molded, a compression molded, a 3-D printed, and/or a thermoformed composition. In some aspects, the polymeric composition can be comprised in an article of manufacture. In some aspects, the article can be computer part. The computer can be a desktop computer, laptop computer, notebook computer, cell phone, computer tablet, calculator or the like. In some aspects, the article of manufacture can be a computer chassis, monitor chassis, computer peripheral chassis or chassis part, such as a desktop computer chassis or chassis part or a laptop computer chassis or chassis part. In some aspects, the recycle content and renewable content of the article, and/or a part thereof can be at least 70%, at least 80%, at least 85%, at least 90%, at least 95%, at least 98%, at least 99%, or 100%, or 70% to 100%, or 70% to 98%, or 70% to 95%, or 70% to 90%, or 70% to 85%, or 70% to 80%, or 70% to 75%, or 75% to 100%, or 75% to 98%, or 75% to 95%, or 75% to 90%, or 75% to 85%, or 75% to 80%, or 80% to 100%, or 80% to 98%, or 80% to 95%, or 80% to 90%, or 80% to 85%, or 85% to 100%, or 85% to 98%, or 85% to 95%, or 85% to 90%, or 90% to 100%, or 90% to 98%, or 90% to 95%, or 95% to 100%, or 95% to 98%.

One aspect of the present invention is directed to a computer chassis, monitor chassis, and/or computer peripheral chassis containing a polymeric composition described herein. The computer chassis can be for a desktop computer, a laptop computer, a notebook computer, or a mobile device (e.g., a cell phone, a computer tablet, a calculator or the like). Certain aspects are directed to a desktop computer chassis, or a laptop computer chassis, a computer tablet chassis, computer screen chassis, and/or computer peripheral chassis containing a polymeric composition described herein. In some aspects, the recycle content and renewable content of the computer screen chassis, and/or computer peripheral chassis, and/or a part thereof can be at least 70%, at least 80%, at least 85%, at least 90%, at least 95%, at least 98%, at least 99%, or 100%, or 70% to 100%, or 70% to 98%, or 70% to 95%, or 70% to 90%, or 70% to 85%, or 70% to 80%, or 70% to 75%, or 75% to 100%, or 75% to 98%, or 75% to 95%, or 75% to 90%, or 75% to 85%, or 75% to 80%, or 80% to 100%, or 80% to 98%, or 80% to 95%, or 80% to 90%, or 80% to 85%, or 85% to 100%, or 85% to 98%, or 85% to 95%, or 85% to 90%, or 90% to 100%, or 90% to 98%, or 90% to 95%, or 95% to 100%, or 95% to 98%. The recyclable and/or renewable material of the computer chassis can contain plastics and/or carbon fibers.

One aspect of the present invention is directed to method of making a computer chassis, monitor chassis, and/or computer peripheral chassis, the method comprising forming at least a portion of the computer chassis, computer screen chassis, and/or computer peripheral with the polymeric composition.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to other aspects of the invention. It is contemplated that any embodiment discussed herein can be implemented with respect to any method or composition of the invention, and vice versa. Furthermore, compositions the invention can be used to achieve methods of the invention.

The following includes definitions of various terms and phrases used throughout this specification.

As used herein information technology and telecommunications equipment (ITE) waste refers to the waste of electronic products, such as electronic products that are unwanted, not working, and/or nearing or at the end of their useful life. Electronic products can include, but are not limited to, computers, televisions, printers, cellphones, copiers, fax machines, and other everyday electronic products).

As used herein recycle content or recycled content of a material refers to material or the part of a material that has been reprocessed and obtained from, made from, and/or recovered from a waste stream. Unless mentioned otherwise the waste can be post-industrial or post-consumer waste. Post-consumer waste is a waste generated by a customer of a substrate containing the material. Post-industrial waste is waste generated during a production process of a product and has not been used in the consumer market.

As used herein closed-loop post-consumer recycled resin refers to resin that is reprocessed and the recyclate produced is used to manufacture another product in the same product category.

As used herein renewable content of a material refers to material or the part of a material obtained from or made from a source that is capable of being renewed at the same or a greater rate than it is used and/or the source is not depleted. Examples of renewable content include bio-based renewable material or material produced from sources of waste that are consistently produced, such as CO₂. In some instances, the renewable content is produced using a renewable energy source. Unless mentioned otherwise, bio-based material can include materials from any life form such as plants, animals, fungi, protists, prokaryotes, microbes, algae, bacteria, yeasts and/or molds. The bio-based material can be obtained from natural or genetically engineered species. Non-limiting examples of bio-based renewable material includes tall oil, sugar, castor beans, and/or CO₂, such as waste CO₂.

As used herein total recycled and renewable content of a material refers to wt. % of the material obtained from, made from and/or recovered from waste and wt. % of the material obtained from or made from a renewable material. For example, for a 100 gm material with 10 gm obtained from a recycled sourced and 10 gm obtained from a renewable source, the total recycled and renewable content of the material is 20 wt. %.

Computer chassis as used herein refers to housing and/or casing component for the computer and/or parts of the computer. The computer and/or parts of the computer can include a central processing unit (CPU), monitor, display of the monitor, input device such as keyboard, mouse and/or mouse pad, storage unit such as solid state drive, hard disk drive, graphics processing unit, random access memory, sound card, speakers, microphones, webcam and/or motherboard.

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “wt. %,” “vol. %,” or “mol. %” refers to a weight percentage of a component, a volume percentage of a component, or molar percentage of a component, respectively, based on the total weight, the total volume of material, or total moles, that includes the component. In a non-limiting example, 10 grams of component in 100 grams of the material is 10 wt. % of component. The term “ppm” refer to parts per million by weight, based on the total weight, of material that includes the component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The phrase “and/or” means and or or. To illustrate, A, B, and/or C includes: A alone, B alone, C alone, a combination of A and B, a combination of A and C, a combination of B and C, or a combination of A, B, and C. In other words, “and/or” operates as an inclusive or.

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The polymeric composition of the present invention can “comprise,” “consist(s) essentially of,” or “consist of” particular ingredients, components, compositions, etc. disclosed throughout the specification. In one aspect of the present invention, and with reference to the transitional phrase “consist(s) essentially of” or “consisting essentially of,” a basic and novel characteristic of the present invention can include the polymeric compositions having (1) high recycle and renewable content and/or (2) high impact strength properties.

All publications mentioned herein are incorporated herein by reference to disclose and describe the methods and/or materials in connection with which the publications are cited.

Other objects, features and advantages of the present invention will become apparent from the following detailed description and examples. It should be understood, however, that the detailed description and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings. While the invention is susceptible to various modifications and alternative forms, specific embodiments thereof are shown by way of example in the drawings. The drawings may not be to scale.

FIG. 1 illustrates a schematic of various ITE and non-ITE waste polymer recycling methods.

FIG. 2A and FIG. 2B illustrate a schematic of a composition used according to an example of the present invention.

### DETAILED DESCRIPTION OF THE INVENTION

Herein is a solution to at least some of the problems that may be associated with increasing the recycle content of an information technology and telecommunications equipment (ITE) waste derived polycarbonate/acrylonitrile butadiene styrene (PC/ABS) blend containing polymeric composition without detrimentally jeopardizing the usability of the composition in an article of manufacture (e.g., a chassis for an electronic device). In one aspect of the present invention, the discovery can include a polymeric composition containing 10 wt. % to 70 wt. % of the post-consumer recycled information technology and telecommunications equipment (ITE) waste derived PC/ABS blend, 5 wt. % to 30 wt. % of a filler, 5 wt. % to 30 wt. % of a flame retardant. In some instances, the filler and/or flame retardant can be obtained from a renewable source, a recycled source, and/or may be from the same source as the post-consumer recycled information technology and telecommunications equipment (ITE) waste derived PC/ABS blend. In some instances, the polymeric composition can have a total recycle and renewable content of 50 wt. % to 90 wt. %. In some aspects, the polymeric composition further contains a non-ITE derived post-consumer recycled resin, PC/ABS virgin blend; and/or polycarbonate (PC) resin. In some instances, the PC/ABS virgin blend and/or polycarbonate (PC) resin may be derived from a renewable source or renewable sources. The mechanical properties of such compositions can be sufficient for use in articles of manufacture that may have substantial use and/or may be prone to dropping (e.g., a chassis for an electronic device). Notably, the high recycle and renewable content of the compositions of the present invention can lead to a more sustainable or “green” article of manufacture without compromising costs and/or mechanical strength.

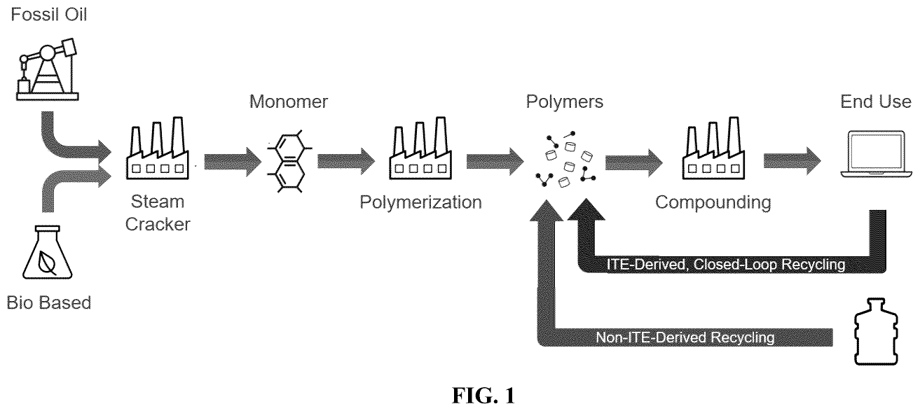

Referring to FIG. 1, a schematic of a non-limiting example of a polymer plastics recycling methods is provided. Polymers (e.g., polycarbonate, PC; acrylonitrile butadiene styrene, ABS) derived from fossil oil can be used to form various articles of manufacture (e.g., consumer products, such as computer chassis), which after use can become waste. Polymers are primarily recycled from the waste through mechanical recycling. In mechanical recycling, the waste is recycled through physical processes where the polymer chains are not reduced into monomer units forming the polymer. Rather, mechanical recycling typically includes collecting the waste having the target polymer (e.g., polycarbonate-based plastics), optionally washing the waste, melting the waste into a raw material having the target polymer, and reusing the raw material to produce new articles of manufacture. However, the mechanical properties of the mechanically recycled polymer can decrease due to the heat used in melting. The heat can weaken the molecular chains of the polymers. Polymers can also be recycled from waste by chemical recycling. In chemical recycling the polymers from the waste is depolymerized into the monomer units and the monomer units are re-polymerized to form the chemically recycled polymer. Further, polymers formed from bio-based chemicals can be also used to form the articles of manufacture increasing the renewable content of the articles. In certain aspects of the present invention, recycled and/or renewable content of a polymeric composition is increased while maintaining the desired mechanical properties of the composition by supplementing mechanical recycled ITE waste derived PC/ABS blend including additives content with non-ITE derived post-consumer recycled resin, fillers, and/or renewably sourced flame retardant, and optionally PC/ABS virgin blend and/or polycarbonate (PC) resin derived from a renewable source.

These and other non-limiting aspects of the present invention are discussed in further detail in the following sections.

### A. Polymeric Compositions

The polymeric composition can contain i) 10 wt. % to 70 wt. % or at least any one of, equal to any one of, or between any two of 10, 15, 20, 25, 30, 35, 40, 45, 50, 55, 60, 65 and 70 wt. % of a post-consumer recycled information technology and telecommunications equipment (ITE) waste derived polycarbonate/acrylonitrile butadiene styrene (PC/ABS) blend; ii) 5 wt. % to 30 wt. % or at least any one of, equal to any one of, or between any two of 5, 10, 15, 20, 25, and 30 wt. % of a filler, wherein, in some instances, at least a portion of the fillers can be obtained from a post-consumer recycled ITE waste source or a renewable source; and iii) 5 wt. % to 30 wt. % or at least any one of, equal to any one of, or between any two of 5, 7, 9, 10, 11, 13, 15, 17, 19, 21, 23, 25, 27, and 30 wt. % of a flame retardant, wherein, in some instances, at least a portion of the fillers can be obtained from a post-consumer recycled ITE waste source or a renewable source.

In certain aspects, the polymeric composition can further contain one or more additives selected from pigments, plasticizers, antioxidants, UV-stabilizers, heat stabilizers, dye enhancing agents, lubricant, mold release agents, crystal nucleating agents, fluidability-improving agents, antistatic agents, compatibilizers, or anti-drip agents. In certain aspects, the polymeric composition can contain pigments and plasticizer.

In certain aspects, the polymeric composition can contain i) 15 wt. % to 25 wt. % or at least any one of, equal to any one of, or between any two of 15, 17, 19, 21, 23, and 25 wt. % of a post-consumer recycled ITE waste derived PC/ABS blend; ii) 45 wt. % to 55 wt. % or at least any one of, equal to any one of, or between any two of 45, 47, 49, 51, 53, and 55 wt. % a non-ITE derived post-consumer recycled resin; iii) 20 wt. % to 30 wt. % or at least any one of, equal to any one of, or between any two of 20, 23, 25, 27, and 30 wt. % of a combination of filler and flame retardant, wherein at least a portion of the fillers are obtained from a post-consumer recycled ITE waste source and at least a portion of the flame retardant obtained from a renewable source; iv) 2 wt. % to 5 wt. % or at least any one of, equal to any one of, or between any two of 2, 2.5, 3, 3.5, 4, 4.5, and 5 wt. % of a PC/ABS virgin blend.

In certain aspects, the polymeric composition can further contain a non-ITE derived post-consumer recycled resin, a PC/ABS virgin blend, and/or polycarbonate (PC) resin derived from a renewable source. In some aspects, the polymeric composition may contain 45 wt. % to 55 wt. % of the non-ITE derived post-consumer recycled resin. In some aspects, the polymeric composition may include at least any one of, at most any one of, equal to any one of, or between any two of 40, 41, 42, 43, 44, 45, 46, 47, 48, 49, 50, 51, 52, 53, 54, 55, 56, 57, 58, 59 or 60 wt. % of the non-ITE derived post-consumer recycled resin. In some aspects, the non-ITE derived post-consumer recycled resin can be originated from mechanically recycled plastics. In some aspects, the non-ITE derived post-consumer recycled resin can be originated from mechanically recycled plastic bottles and/or plastic containers. In some aspects, the polymeric composition may exclude a non-ITE derived post-consumer recycled resin. In some aspects, the polymeric composition may contain 2 wt. % to 5 wt. % of the PC/ABS virgin blend. In some aspects, the polymeric composition may include at least any one of, at most any one of, equal to any one of, or between any two of 1, 2, 3, 4, 5, 6, 7, 8, 9, 10 wt. % of the PC/ABS virgin blend. In some aspects, the PC/ABS virgin blend is derived from a renewable source. In some aspects, the polymeric composition may exclude a polycarbonate (PC) resin derived from a renewable source. In some aspects, the polymeric composition may contain 0 wt. % to 50 wt. % of the polycarbonate (PC) resin derived from a renewable source. In some aspects, the polymeric composition may include at least any one of, at most any one of, equal to any one of, or between any two of 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55 wt. % of the polycarbonate (PC) resin derived from a renewable source. In some aspects, the polymeric composition may exclude a polycarbonate (PC) resin derived from a renewable source.

The polymeric composition can have a total recycled content of 50 wt. % to 90 or at least any one of, equal to any one of, or between any two of 50, 55, 60, 65, 70, 75, 80, 85, and 90 wt. %.

In certain aspects, the polymeric composition of the present invention can have any one of, any combination of, or all of the following properties: a tensile modulus equal to or greater than 3800 MPa, or 3800 MPa to 4200 MPa, or 3800 MPa to 4400 MPa, or 3800 MPa to 4600 MPa, or 4000 MPa to 4600 MPa at 23° C., as measured in accordance with ASTM D638; a tensile strength at break equal to or greater than 45 MPa, or 45 MPa to 60 MPa, or 45 MPa to 65 MPa, or 45 MPa to 70 MPa, or 50 MPa to 65 MPa, or 50 MPa to 70 MPa, or 55 MPa to 65 MPa, or 55 MPa to 70 MPa at 23° C., as measured in accordance with ASTM D638; a tensile elongation at break ≥8%, or ≥8.2%, or ≥8.4%, or ≥8.5%, or ≥7.9%, or ≥7.8%, or 7.8% to 9%, or 7.8% to 10%, or 7.8% to 11%, or 7.8% to 15%, or 7.8% to 8.5%, or 8% to 9%, or 8% to 10%, or 8% to 11%, or 8% to 15%, or 8% to 8.5% at 23° C., as measured in accordance with ASTM D638; and a Notched Izod Impact strength greater than 4 kJ/m², or greater than 4.2 kJ/m², or greater than 4.4 KJ/m², or greater than 4.5 kJ/m², or greater than 5 KJ/m², or greater than 5.5 KJ/m², or greater than 6 kJ/m², or greater than 6.5 kJ/m², or greater than 7 kJ/m², or greater than 7.5 kJ/m², or 4.1 kJ/m² to 10 KJ/m², or 4.1 kJ/m² to 9 KJ/m², or 4.1 kJ/m² to 8 KJ/m², or 4.1 kJ/m² to 7 KJ/m², or 4.1 kJ/m² to 6 kJ/m², or 4.1 kJ/m² to 7 kJ/m², or 4.1 kJ/m² to 6 kJ/m², or 4.1 kJ/m² to 5 kJ/m², or 4.1 kJ/m² to 4.5 kJ/m², or 4.1 kJ/m² to greater than 10 KJ/m², or 4.1 kJ/m² to 11 kJ/m², or 4.1 kJ/m² to 12 kJ/m², or 5 kJ/m² to 10 KJ/m², or 5 KJ/m² to 9 KJ/m², or 5 kJ/m² to 8 KJ/m², or 5 kJ/m² to 7 kJ/m², or 5 kJ/m² to 6 kJ/m², or 5 kJ/m² to 7 KJ/m², or 5 kJ/m² to 6 kJ/m², or 5 kJ/m² to 5 KJ/m², or 5 kJ/m² to 4.5 kJ/m², or 5 kJ/m² to greater than 10 KJ/m², or 5 KJ/m² to 11 kJ/m², or 5 kJ/m² to 12 kJ/m², at 23° C., as measured in accordance with ASTM D256.

### 1. Polycarbonates

The polycarbonates, such as the post-consumer mechanical recycled polycarbonate and the renewably sourced polycarbonate can contain carbonate units. The carbonate units can have the formula of formula (1)

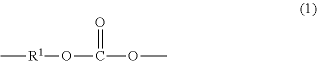

R¹ groups can contain aliphatic or aromatic groups. The carbonate units can be derived from sugars, hydroxy containing aliphatic groups and/or hydroxy aromatic groups. R¹ groups of the post-consumer mechanical recycled polycarbonate and the renewably sourced polycarbonate can be the same or different. In certain aspects, the carbonate units can be derived from bisphenol A (BPA), e.g. carbonate units having the formula of formula (2)

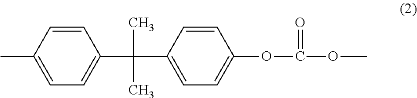

The polycarbonates can be homo-polymers and/or co-polymers. In polycarbonate homo-polymer each R¹ group in the polymer can be the same. The polycarbonate copolymers can contain polycarbonate containing different R¹ groups or polymers containing carbonate units (having same or different R¹), and other types of polymer units, such as ester units.

The post-consumer mechanical recycled polycarbonate can at least in part, be obtained by mechanical recycling of post-consumer waste containing polycarbonates. The post-consumer polycarbonate waste can be mechanically recycled by a suitable mechanical recycling method known in the art. Mechanical recycling of a polymer refers to recycling of the polymer from a waste material containing the polymer through a physical process where the polymer chains are not broken (e.g. chemically depolymerized) into the monomer units forming the polymer. In some aspects, the mechanical recycling can include the steps of grinding, washing, separating, drying, re-granulating and compounding, wherein each of the steps can occur 0 to multiple times. In some aspects, the mechanically recycled content in the post-consumer mechanical recycled polycarbonate can be, or the post-consumer mechanical recycled polycarbonate can have a recycle content of 80 wt. % to 100 wt. %, or 90 wt. % to 100 wt. %, or 95 wt. % to 100 wt. %, or 98 wt. % to 100 wt. %, or 99 wt. % to 100 wt. %, or about 100 wt. %, with the rest optionally being virgin polycarbonate.

The post-consumer mechanical recycled polycarbonate can contain polycarbonate homo-polymers and/or co-polymer. In certain aspects, the post-consumer mechanical recycled polycarbonate can contain carbonate units derived from bisphenol A (BPA) (e.g. formula 2). In certain aspects, the post-consumer mechanical recycled polycarbonate can contain homo-polymer(s) containing carbonate units derived from BPA. In certain aspects, the post-consumer mechanical recycled polycarbonate can contain co-polymer(s) containing carbonate units derived from BPA and other carbonate units and/or other types of polymer units. In some aspects, post-consumer mechanical recycled polycarbonate can include a combination of polycarbonate polymers.

The renewably sourced polycarbonate can at least in part, be obtained from a renewable feed stock. The renewably sourced polycarbonate can be a suitable polycarbonate known in the art. The renewably sourced polycarbonate can be a obtained from the renewable feed stock by methods known in the art. The renewably sourced polycarbonate can include polycarbonate homo-polymer and/or co-polymers. In certain aspects, the renewably sourced polycarbonate can contain homo-polymer(s) containing carbonate units derived from BPA (e.g. formula 2). In certain aspects, the renewable feed stock can be tall oil, sugar, castor beans and/or CO₂ such as CO₂ obtained from industrial waste. In some aspects, at least a portion of the CO₂ can be obtained from industrial waste. In some aspects, the sugar can be a sugar moiety in a thymidine group and/or a thymidine derivative. In some aspects, the renewably sourced polycarbonate can be a polycarbonate-polyester copolymer containing ester units derived from sebacic acid. The sebacic acid can be obtained from castor beans. In some aspects, the renewably sourced polycarbonate can be obtained from feed stock obtained from tall oil from wood pulp. In some aspects, the renewably sourced polycarbonate can contain carbonate units derived from BPA, where the BPA is obtained from feed stock obtained from tall oil from wood pulp. In some aspects, the renewably sourced polycarbonate can be a homo-polymer containing carbonate units derived from BPA, where the BPA is obtained from feed stock obtained from tall oil from wood pulp. In some aspects, the renewably sourced polycarbonate can obtained from phenol and acetone, wherein the phenol, and/or acetone, can be at least in part obtained independently from renewable feed stock(s). In some aspects, the renewably sourced polycarbonate can be a BPA polycarbonate homo-polymer obtained from phenol and acetone, wherein the phenol, and/or acetone, can be at least in part obtained independently from renewable feed stock(s). In some aspects, at least a portion of the carbons in the renewably sourced polycarbonate can be derived from the renewable feed stock. In some aspects, at least a portion of the oxygens and/or hydrogens in the renewably source polycarbonate can be derived from renewable sources. In some aspects, at least a portion of the carbons, oxygens, and/or hydrogens in the renewably source polycarbonate can be derived from non-renewable sources. In some aspects, at least 70%, or at least 80%, or at least 90%, or at least 95%, or 100% of the carbons in the renewably sourced polycarbonate can be derived from the renewable feed stock. In some aspects, the renewably sourced polycarbonate can be a homo-polymer containing carbonate units derived from BPA.

In some aspects, the polymeric composition may include 0 wt. % to 50 wt. %, or at least any one of, equal to any one of, or between any two of 0, 5, 10, 15, 20, 25, 30, 35, 40, 45 and 50 wt. % of the of the renewably sourced polycarbonate produced from the renewable feedstock. In some aspects, the renewably sourced polycarbonate can include a combination of polycarbonate polymers.

### 2. PC/ABS (Polycarbonate/Acrylonitrile Butadiene Styrene)

Polycarbonate/acrylonitrile butadiene styrene (PC/ABS) is a blend of PC and ABS. Due to its mechanical properties, this material has high strength, high stiffness, high heat resistance, and high impact resistance, even at low temperatures. PC/ABS retains its dimensional stability over time and its enhanced flow characteristics and processability make it easy to work with these polymer blends on the market with a cost-advantage. Since PC/ABS is colorable and printable, designers have a lot of freedom when working with this material.

The post-consumer recycled ITE waste derived PC/ABS blend can contain a blend of polycarbonate homo-polymers and an ABS (acrylonitrile butadiene styrene) terpolymer. In certain aspects, the post-consumer mechanical recycled ITE waste derived PC/ABS blend can contain carbonate units derived from bisphenol A (BPA) (e.g., formula 2) and terpolymer ABS unit (e.g., formula 3) produced by polymerizing styrene and acrylonitrile in the presence of polybutadiene.

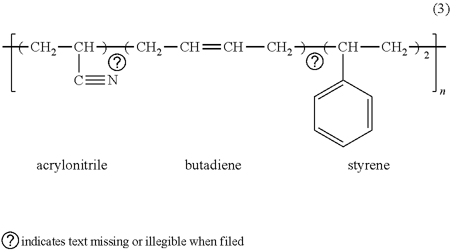

In certain aspects, the post-consumer mechanical recycled ITE waste derived PC/ABS blend may contain various ratios of PC to ABS in its blend composition. In some aspects, the post-consumer recycled ITE waste derived PC/ABS blend may have fillers. In some aspects, the post-consumer recycled ITE waste derived PC/ABS blend may have flame retardants. In some aspects, the post-consumer recycled ITE waste derived PC/ABS blend may include a combination of additives, wherein the additive is a pigment, a plasticizer, an antioxidant, an UV-stabilizer, a heat stabilizer, a dye enhancing agent, a lubricant, a mold release agent, a crystal nucleating agent, a fluidability-improving agent, an antistatic agent, a compatibilizer, an anti-drip agent, or any combination thereof.

The post-consumer recycled ITE waste derived PC/ABS blend can at least in part, be obtained by mechanical recycling of post-consumer waste containing PC/ABS blend. The post-consumer recycled ITE waste derived PC/ABS blend can be mechanically recycled by a suitable mechanical recycling method known in the art. Mechanical recycling of a polymer refers to recycling of the polymer from a waste material containing the polymer through a physical process where the polymer chains are not broken (e.g. chemically depolymerized) into the monomer units forming the polymer. In some aspects, the mechanical recycling can include the steps of grinding, washing, separating, drying, re-granulating and compounding, wherein each of the steps can occur 0 to multiple times. In some aspects, the mechanically recycled content in the post-consumer recycled ITE waste derived PC/ABS can be, or the post-consumer mechanical recycled ITE waste derived PC/ABS can have a recycle content of 70 wt. % to 100 wt. %, 80 wt. % to 100 wt. %, or 90 wt. % to 100 wt. %, or 95 wt. % to 100 wt. %, or 98 wt. % to 100 wt. %, or 99 wt. % to 100 wt. %, or about 100 wt. %, with the rest optionally being virgin PC/ABS blend.

In some aspects, the polymeric composition disclosed here may contain 10 wt. % to 70 wt. % or at least any one of, equal to any one of, or between any two of 10, 15, 20, 25, 30, 35, 40, 45, 50, 55, 60, 65 and 70 wt. % of a post-consumer recycled information technology and telecommunications equipment (ITE) waste derived polycarbonate/acrylonitrile butadiene styrene (PC/ABS) PC/ABS blend.

In some aspects, the polymeric composition disclosed here may contain 0 wt. % to 5 wt. % or at least any one of, equal to any one of, or between any two of 0, 0.5, 1, 1.5, 2, 2.5, 3, 3.5, 4, 4.5, and 5 wt. % of a PC/ABS virgin blend. Virgin resin here refers to the resin, which is manufactured from natural resources such as petrochemical feedstock, crude oil, natural gas, etc.

### 3. Non-ITE Derived Post-Consumer Recycled Resin

Non-ITE derived post-consumer recycled resin (Non-ITE PCR resin) is a material made from recycled plastic, such as water and beverage bottles and other packaging units, which are not derived from information technology and telecommunications equipment (ITE) equipment waste. The non-ITE derived post-consumer mechanical recycled resin may, at least in part, be obtained by mechanical recycling of post-consumer waste containing polycarbonate bottles.

In some aspects, the polymeric composition disclosed here may contain 0 wt. % to 80 wt. %, such as 45 wt. % to 55 wt. %, or at least any one of, at most any one of equal to any one of, or between any two of 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80 wt. % a non-ITE derived post-consumer recycled resin.

### 4. Filler

The polymeric composition may contain 5 wt. % to 30 wt. % or at least any one of, equal to any one of, or between any two of 5, 10, 15, 20, 25, and 30 wt. % of a filler, wherein at least a portion of the fillers may be obtained from a post-consumer recycled ITE waste source The fillers in the composition can include, but are not limited to, talc, glass, mineral, carbon, or a combination thereof.

Glass filler in the polymeric composition may be comprised of fibers, milled fibers, particles, chips, spheres, hollow spheres and mixtures thereof. The glass fibers can be staple fibers, continuous fibers and mixtures thereof, and fibers having a circular, oval, elliptical, square or rectangular cross-section. The glass filler can have a length of 1 mm to 25 mm, or at least any one of, equal to any one of, or between any two of 1 mm, 5 mm, 10 mm, 15 mm, 20 mm and 25 mm. The glass fibers may have an aspect ratio, e.g., the ratio of the main cross-sectional axis to the secondary cross-sectional axis, of 1.5 to 8, or 2 to 6, or 3 to 5.

Mineral fillers in the polymeric composition may have any shape, or any crystallographic form (for example sheet, cubic, hexagonal, orthorhombic, etc.). They may be made of talc, mica, silica, kaolin, boron nitride, precipitated calcium carbonate, magnesium carbonate, magnesium hydrogen carbonate, hydroxyapatite, hollow silica microspheres, or glass or ceramic microcapsules, clay, quartz, natural diamond powder, or mixtures thereof.

Carbon fibers can at least in part, be post-industrial recycled carbon fibers (e.g., obtained by recycling post-industrial waste). The carbon fibers can be any suitable carbon fibers. The fibers can be sized, unsized, continuous, chopped, seeded, or non-continuous fibers or any combinations thereof. The sized fibers can be sized with a suitable sizing agent. The fibers can have a suitable length and diameter. The carbon fibers can contain standard modulus, intermediate modulus and/or high modulus carbons. In some aspects, the fibers can be provided in bundles

In certain aspects, the carbon fibers can have average length of 1 to 100 mm, or at least any one of, equal to any one of, or between any two of 1, 10, 20, 30, 40, 50, 60, 70, 80, 90 and 100 mm. In certain aspects, the carbon fibers can have average filament diameter of 1 μm to 30 μm or at least any one of, equal to any one of, or between any two of 1, 5, 10, 15, 20, 25, and 30 μm. In certain aspects, the carbon fibers can have a sizing content of 0.5 wt. % to 10 wt. % or at least any one of, equal to any one of, or between any two of 0.5, 1, 2, 3, 4, 5, 6, 7, 8, 9 and 10 wt. %. In certain aspects, the carbon fibers can have a carbon density of 1.5 g/cc to 2 g/cc or 1.75 g/cc to 1.85 g/cc or at least any one of, equal to any one of, or between any two of 1.5, 1.6, 1.7, 1.75, 1.78, 1.8, 1.85, 1.9, 1.95, and 2 g/cc. In some, the carbon fibers have tensile modulus of 30 Msi to 55 Msi or at least any one of, equal to any one of, or between any two of 30, 31, 32, 33, 34, 35, 36, 37, 38, 39, 40, 41, 42, 43, 44, 45, 46, 47, 48, 49, 50, 51, 52, 53, 54, and 55 Msi. In some aspects, the carbon fibers can have a recycled content of 10 wt. % to 30 wt. % or at least any one of, equal to any one of, or between any two of 10, 15, 20, 25 and 30 wt. %. Examples of carbon fibers that can be used includes but are not limited to, RE-EVOR HSC commercially available from CARBONCONVERSIONS.

### 5. Flame Retardants

In some aspects, the flame retardant can be obtained, at least in part, from a renewable source and/or a recycled source. In some aspects, the renewable and/or recycled content of the flame retardant can be 5 wt. % to 30 wt. %, or at least any one of, equal to any one of, or between any two of 5, 7, 9, 11, 13, 15, 17, 19, 21, 23, 25, 27, and 30 wt. %. In some aspects, the flame retardant can be a non-halogenated flame retardant. In some aspects, the flame retardant can be a non-halogenated phosphorus containing flame retardant obtained from bio-based chemicals. In some aspects, the bio-based chemicals can be tannin, tannic acid, phytic acid, isosorbide, diphenolic acid, deoxyribonucleic acid (DNA), lignin, or β-cyclodextrin or any combination thereof. In some aspects, the flame retardant can contain Bisphenol-A-diphosphate obtained from bio-based chemicals.

### 6. Additives

Plasticizers, lubricants, and/or mold release agent additives may also be used. There is considerable overlap among these types of materials, which include, for example, phthalic acid esters such as dioctyl-4,5-epoxy-hexahydrophthalate; tris-(octoxycarbonylethyl) isocyanurate; tristearin; di- or polyfunctional aromatic phosphates such as resorcinol tetraphenyl diphosphate (RDP), the bis(diphenyl) phosphate of hydroquinone and the bis(diphenyl) phosphate of bisphenol-A; poly-alpha-olefins; epoxidized soybean oil; silicones, including silicone oils; esters, for example, fatty acid esters such as alkyl stearyl esters, e.g., methyl stearate; stearyl stearate, pentaerythritol tetrastearate, and the like; mixtures of methyl stearate and hydrophilic and hydrophobic nonionic surfactants comprising polyethylene glycol polymers, polypropylene glycol polymers, and copolymers thereof, e.g., methyl stearate and polyethylene-polypropylene glycol copolymers in a suitable solvent; waxes such as beeswax, montan wax, paraffin wax or the like.

Colorants such as pigment and/or dye additives may also be present in the polymeric composition. Suitable pigments include for example, inorganic pigments such as metal oxides and mixed metal oxides such as zinc oxide, titanium dioxides, iron oxides or the like; sulfides such as zinc sulfides, or the like; aluminates; sodium sulfo-silicates sulfates, chromates, or the like; carbon blacks; zinc ferrites; ultramarine blue; Pigment Brown 24; Pigment Red 101; Pigment Yellow 119; organic pigments such as azos, di-azos, quinacridones, perylenes, naphthalene tetracarboxylic acids, flavanthrones, isoindolinones, tetrachloroisoindolinones, anthraquinones, anthanthrones, dioxazines, phthalocyanines, and azo lakes; Pigment Blue 60, Pigment Red 122, Pigment Red 149, Pigment Red 177, Pigment Red 179, Pigment Red 202, Pigment Violet 29, Pigment Blue 15, Pigment Green 7, Pigment Yellow 147, and Pigment Yellow 150, or any combination thereof.

### B. Methods for Making the Polymeric Compositions

The thermoplastic compositions of the present invention can be made by various methods known in the art such as extrusion, injection molding, compression molding, blow molding, rotational molding, thermoforming, 3-D printing, or any combination thereof. For example components, such as post-consumer recycled ITE waste derived PC/ABS blend, non-ITE derived post-consumer recycled resin, PC/ABS virgin blend, renewably sourced polycarbonate, fillers, flame retardant, and/or additives can be mixed together and then melt-blended to form the polymeric composition.

In some aspects, one or any of the components described herein may be first dry blended with each other, or dry blended with any combination of the components, then fed into an extruder from one or multi-feeders, or separately fed into an extruder from one or multi-feeders. The extruders used in the invention may have a single screw, multiple screws, intermeshing co-rotating or counter rotating screws, non-intermeshing co-rotating or counter rotating screws, reciprocating screws, screws with pins, screws with screens, barrels with pins, rolls, rams, helical rotors, co-kneaders, disc-pack processors, various other types of extrusion equipment, or combinations comprising at least one of the foregoing. The extruder can generally be operated at a temperature higher than that necessary to cause the composition to melt and flow. In some aspects, the temperature of the melt in the extruder barrel can be maintained as low as possible in order to avoid excessive thermal degradation of the components. The melted composition exits the extruder through small exit holes in a die. The extrudate can be quenched in a water bath and pelletized. The pellets can be of any desired length (e.g., one-fourth inch long or less). Such pellets can be used for subsequent molding, shaping, or forming.

Mixtures including any combination of the components may be subjected to multiple blending and forming steps if desirable. For example, the polymeric composition may first be extruded and formed into pellets. The pellets may then be fed into a molding machine where it may be formed into any desirable shape or product. In some aspects, the thermoplastic composition emanating from a single melt blender may be formed into sheets or strands and subjected to post-extrusion processes such as annealing, uniaxial or biaxial orientation.

### C. Articles of Manufacture

The polymeric composition of the present invention can be comprised in an article of manufacture. Aspects of the disclosure also relate to articles including the polymeric composition described herein. In some aspects the article can be a film, a sheet, a molded article, a welded article, a filament or a powder. In one example, the composition can be incorporated into a film. The film may include at least one film layer that includes the thermoplastic composition. In further aspects the film includes at least a second film layer. Other film layers may include other materials.

The article can be a consumer product. In some aspects, the article can be a computer part. The computer can be a desktop computer, laptop computer, notebook computer, cell phone, computer tablet, calculator or the like. In some particular aspects, the article can be a computer chassis or chassis part, such as a desktop computer chassis or chassis part or a laptop computer chassis or chassis part. In some aspects, the article can be a computer chassis, monitor chassis, and/or computer peripheral chassis. In some aspects, the computer chassis can be a desktop computer chassis, a laptop computer chassis, or a computer tablet chassis. In some aspects, at least 70 wt. % of or at least any one of, equal to any one of, or between any two of 50 wt. % to 60 wt. %, or 60 wt. % to 70 wt. %, or 70 wt. % to 80 wt. %, or 80 wt. % to 90 wt. %, or 90 wt. % to 100 wt. % of the computer chassis, computer screen chassis, and/or computer peripheral chassis can contain a polymeric composition described herein. At least 70 wt. %, such as 70 wt. % to 100 wt. % of the computer chassis, computer screen chassis, and/or computer peripheral chassis can be comprised of recyclable and/or renewable material, wherein the recyclable and/or renewable material contains plastics, fillers, flame retardants, and/or additives.

In some instances, the laptop or a notebook computer can have a keyboard, a mouse pad, a screen/display, a top cover, a bottom cover, and/or a back cover. In some aspects, the chassis can include at least a portion of a top cover, bottom cover, and/or back cover, or any combination thereof or all thereof. The bottom cover can, in some instances, have space/holes for one or more ports (e.g. including but not limited to USB port(s), HDMI port(s), SD card port(s), VGA connector port(s), microphone and/or speaker port(s), laptop charger port(s), laptop lock slot(s) and/or Ethernet port(s)) configured to attach peripherals such as printers, scanners, storage drives, monitors, speakers, microphones, webcams, USB cables and/or drives, chargers, laptop locks, Ethernet cable, and/or SD cards with the laptop. In some aspects, the top cover and/or the back cover can have one or more holes for one or more ports. The laptop or notebook computer can have central processing unit (CPU), storage unit, graphics processing unit, random access memory, sound card, speakers, webcam, microphone, motherboard and/or battery, in the space between the covers, and/or the space between the screen/display and back cover. In some aspects, the top cover, bottom cover, and/or back cover can contain a polymer composition described herein. In some aspects, independently at least 70 wt. %, such as 70 wt. % to 100 wt. % of the top cover, bottom cover, and/or back cover can contain a polymer composition described herein. Independently, at least 70 wt. %, such as 70 wt. % to 100 wt. % of the top cover, bottom cover, and/or back cover can be comprised of recyclable, low carbon, and/or renewable material, wherein the recyclable, low carbon, and/or renewable material contains aluminum, plastics, and/or carbon fibers.

In some instances, the monitor can have a display screen and a casing. In some aspects, the chassis can include at least a portion of the computer case or casing, or any combination thereof or all thereof. The computer case can house various computer hardware including but not limited to CPU, storage unit, graphics processing unit, random access memory, sound card, and/or motherboard. The computer case can have one or more holes/spaces to attach, e.g., via various ports, various computer hardware and/or peripherals with the computer. The hardware and/or peripherals can include, but are not limited to media drives, e.g., CD drives, printers, scanners, storage drives, monitors, speakers, microphones, webcams, USB cables and/or drives, and/or chargers. In some aspects, the computer case and/or the casing can contain a polymeric composition described herein. In some aspects, independently at least 70 wt. %, such as 70 wt. % to 100 wt. % of the computer case and/or the casing can contain a polymeric composition described herein. Independently, at least 70 wt. %, such as 70 wt. % to 100 wt. % of the computer case and/or the casing can be comprised of recyclable, low carbon, and/or renewable material, wherein the recyclable, low carbon, and/or renewable material contains aluminum, plastics and/or carbon fibers.

In some instances, the tablet computer or cell phone can contain a display screen and a back panel. In some aspects, the chassis can include at least a portion of the back panel. Various tablet computer or cell phone hardware can be housed in between the display and a back panel, such as including but not limited to processors, computer chips, cameras, microphone, speaker, and/or battery. In some aspects, the back panel can be a foldable panel. In some aspects, at least 70 wt. %, such as 70 wt. % to 100 wt. % of the back panel can contain a polymeric composition described herein. At least 70 wt. %, such as 70 wt. % to 100 wt. % of the back panel can be comprised of recyclable and/or renewable material, wherein the recyclable and/or renewable material contains plastics and/or carbon fibers.

In the context of the present invention, at least the following 20 aspects are described. Aspect 1 is directed to polymeric composition comprising: 10 wt. % to 70 wt. % of post-consumer recycled information technology and telecommunications equipment (ITE) waste derived polycarbonate/acrylonitrile butadiene styrene (PC/ABS) blend; 5 wt. % to 30 wt. % of a filler; and 5 wt. % to 30 wt. % of a flame retardant. Aspect 2 is directed to the polymeric composition of aspect 1, further comprising: non-ITE derived post-consumer recycled resin; polycarbonate/acrylonitrile butadiene styrene (PC/ABS) virgin blend; and/or polycarbonate (PC) resin derived from a renewable source. Aspect 3 is directed to the polymeric composition of any one of aspects 1 to 2, comprising: 15 wt. % to 25 wt. % of the post-consumer recycled ITE waste derived PC/ABS blend; 45 wt. % to 55 wt. % of non-ITE derived post-consumer recycled resin; 20 wt. % to 30 wt. % of a combination of flame retardant and filler; and 2 wt. % to 5 wt. % of PC/ABS virgin blend. Aspect 4 is directed to the polymeric composition of any one of aspects 1 to 3, comprising any one of, a combination of, or all of the following properties: a tensile modulus equal to or greater than 3800 MPa at 23° C., as measured in accordance with ASTM D638; a tensile strength at break equal to or greater than 45 MPa at 23° C., as measured in accordance with ASTM D638; a tensile elongation at break equal to or greater than 8%, at 23° C., as measured in accordance with ASTM D638; and/or a Notched Izod Impact strength greater than 4 KJ/m² at 23° C., as measured in accordance with ASTM D256. Aspect 5 is directed to the polymeric composition of any one of aspects 1 to 4, wherein the renewable source of the polycarbonate resin derived from a renewable source is tall oil, caster beans, sugar, waste carbon dioxide (CO₂), or a combination thereof. Aspect 6 is directed to the polymeric composition of any one of aspects 1 to 5, wherein the polymeric composition comprises no more than 60 wt. % of the post-consumer recycled resin that is not ITE-derived. Aspect 7 is directed to the polymeric composition of any one of aspects 1 to 6, wherein the polymeric composition comprises no more than 50 wt. % of the PC resin derived from a renewable source. Aspect 8 is directed to the polymeric composition of any one of aspects 1 to 7, wherein at least a portion of the filler is obtained from an ITE waste derived post-consumer recycled source. Aspect 9 is directed to the polymeric composition any one of aspects 1 to 8, wherein the filler comprises talc, glass, mineral, carbon, or a combination thereof. Aspect 10 is directed to the polymeric composition any one of aspects 1 to 9, wherein the flame retardant comprises a flame retardant obtained from a renewable source. Aspect 11 is directed to the polymeric composition any one of aspects 1 to 10, wherein the flame retardant is a non-halogenated phosphorus containing flame retardant obtained from bio-based chemicals. Aspect 12 is directed to the polymeric composition any one of aspects 1 to 11, wherein the post-consumer recycled ITE waste derived PC/ABS blend comprises additives. Aspect 13 is directed to the polymeric composition any one of aspects 1 to 12, further comprising an additive, wherein the additive is a pigment, a plasticizer, an antioxidant, an UV-stabilizer, a heat stabilizer, a dye enhancing agent, a lubricant, a mold release agent, a crystal nucleating agent, a fluidability-improving agent, an antistatic agent, a compatibilizer, an anti-drip agent, or any combination thereof. Aspect 14 is directed to the polymeric composition any one of aspects 1 to 13, wherein the composition is comprised in a film, a layer, or a sheet. Aspect 15 is directed to the polymeric composition any one of aspects 1 to 14, wherein the composition is an extruded, blow-molded, injection-molded, rotational molded, compression molded, 3-D printed, and/or thermoformed composition. Aspect 16 is directed to a computer chassis, monitor chassis, and/or computer peripheral chassis comprising the polymeric composition any one of aspects 1 to 15. Aspect 17 is directed to the computer chassis, monitor chassis, and/or computer peripheral chassis of aspect 16, wherein the computer chassis is a desktop computer chassis, a laptop computer chassis, or a computer tablet chassis. Aspect 18 is directed to a method of making a computer chassis, monitor chassis, and/or computer peripheral chassis, the method comprising forming at least a portion of the computer chassis, computer screen chassis, and/or computer peripheral with the polymeric composition of aspect 1. Aspect 19 is directed to the method of aspect 18, wherein at least 70 wt. % of the computer chassis, computer screen chassis, and/or computer peripheral chassis comprises the polymeric composition. Aspect 20 is directed to the method of any one of aspects 18 to 19, wherein the polymeric composition further comprises: non-ITE derived post-consumer recycled resin; polycarbonate/acrylonitrile butadiene styrene (PC/ABS) virgin blend; and/or polycarbonate resin derived from a renewable source.

### D. Examples

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### 1. Example 1—a Polymeric Resin Composition

Table 1 provides a non-limiting resin composition.

TABLE 1
Resin composition

| Components | Wt. % |
|---|---|
| Post-consumer recycled ITE waste derived PC/ABS blend | 20 |
| Non-ITE derived post-consumer recycled resin | 50 |
| PC/ABS virgin blend | 5 |
| Flame retardant | 10 |
| Talc | 15 |
| Total | 100 |

Components of Table 1 were dry blended and melt extruded to form molded compositions containing the resin of Table 1.

Mechanical properties of the molded composition was tested using standard methods. The molded resin composition of Table 1 had a tensile modulus of 3800 MPa, as measured in accordance with ASTM D638, a tensile strength at break of 45 MPa as measured in accordance with ASTM D638, a tensile elongation at break of 8% as measured in accordance with ASTM D638, and a Notched Izod Impact strength of 4 kJ/m² as measured in accordance with ASTM D256.

Components of Table 1 were blended and melt extruded to form pellets containing the resin of Table 1. The pellets were injection molded to form a 1.0 to 1.6 mm thick back panel of a computer chassis, monitor chassis, and/or computer peripheral chassis.

### 2. Example 2—a Polymeric Resin Composition

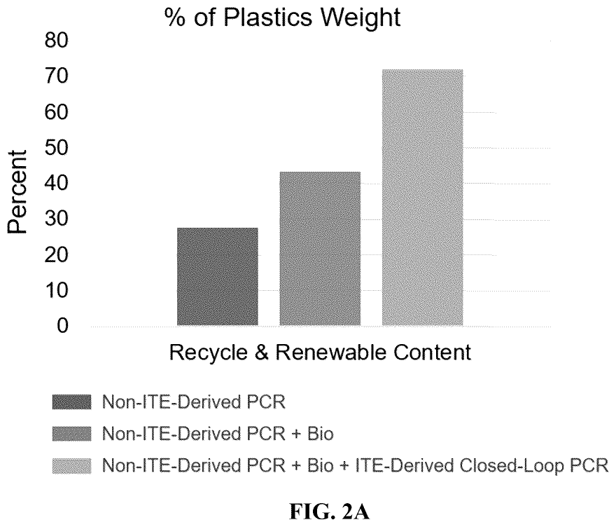

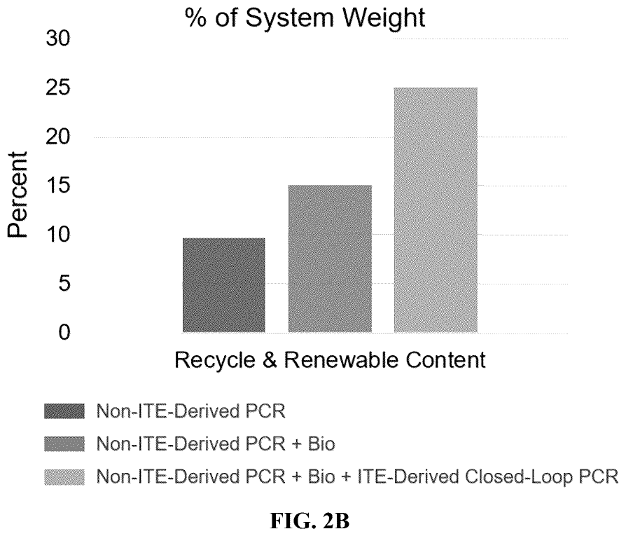

FIG. 2A and FIG. 2B provides weight percentages making up an additional non-limiting polymeric composition. Referring to FIG. 2A, the percentage of a non-ITE derived post-consumer recycled resin making up a polymeric composition is shown in the left most column. The percentage of a combination of the non-ITE derived post-consumer recycled resin and a bio-based resin is shown in the middle column. The percentage of a combination of the non-ITE derived post-consumer recycled resin, the bio-based resin, and a ITE derived post-consumer recycled resin is shown in the right most column. In some instances, the ITE derived post-consumer recycled resin can be a closed-loop post-consumer recycled resin.

Referring to FIG. 2B, the percentage of a non-ITE derived post-consumer recycled resin in a consumer product, such as a computer chassis, is shown in the left most column. The post-consumer recycled resin can be part of a polymeric composition that is part of the consumer product. The percentage of a combination of the non-ITE derived post-consumer recycled resin and a bio-based resin in a consumer product is shown in the middle column. The percentage of a combination of the non-ITE derived post-consumer recycled resin, the bio-based resin, and a ITE derived post-consumer recycled resin in a consumer product is shown in the right most column. In some instances, the ITE derived post-consumer recycled resin can be a closed-loop post-consumer recycled resin. In some instances, the post-consumer recycled resin, the bio-based resin, and/or the ITE derived post-consumer recycled resin can be part of one or multiple polymeric composition(s) that is or are part of the consumer product.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein can be utilized. Accordingly, the appended claims are intended to include within their scope such processes, machines, manufacture, compositions of matter, means, methods, or steps.

1. A polymeric composition comprising:
10 wt. % to 70 wt. % of post-consumer recycled information technology and telecommunications equipment (ITE) waste derived polycarbonate/acrylonitrile butadiene styrene (PC/ABS) blend;
5 wt. % to 30 wt. % of a filler; and
5 wt. % to 30 wt. % of a flame retardant.

2. The polymeric composition of claim 1, further comprising:
non-ITE derived post-consumer recycled resin;
polycarbonate/acrylonitrile butadiene styrene (PC/ABS) virgin blend; and/or
polycarbonate (PC) resin derived from a renewable source.

3. The polymeric composition of claim 2 comprising:
15 wt. % to 25 wt. % of the post-consumer recycled ITE waste derived PC/ABS blend;
45 wt. % to 55 wt. % of non-ITE derived post-consumer recycled resin;
20 wt. % to 30 wt. % of a combination of flame retardant and filler; and
2 wt. % to 5 wt. % of PC/ABS virgin blend.

4. The polymeric composition of claim 3, comprising any one of, a combination of, or all of the following properties:
a tensile modulus equal to or greater than 3800 MPa at 23° C., as measured in accordance with ASTM D638;
a tensile strength at break equal to or greater than 45 MPa at 23° C., as measured in accordance with ASTM D638;
a tensile elongation at break equal to or greater than 8%, at 23° C., as measured in accordance with ASTM D638; and/or
a Notched Izod Impact strength greater than 4 KJ/m² at 23° C., as measured in accordance with ASTM D256.

5. The polymeric composition of claim 2, wherein the renewable source of the polycarbonate resin derived from a renewable source is tall oil, caster beans, sugar, waste carbon dioxide (CO₂), or a combination thereof.

6. The polymeric composition of claim 2, wherein the polymeric composition comprises no more than 60 wt. % of the post-consumer recycled resin that is not ITE-derived.

7. The polymeric composition of claim 2, wherein the polymeric composition comprises no more than 50 wt. % of the PC resin derived from a renewable source.

8. The polymeric composition of claim 1, wherein at least a portion of the filler is obtained from an ITE waste derived post-consumer recycled source.

9. The polymeric composition of claim 1, wherein the filler comprises talc, glass, mineral, carbon, or a combination thereof.

10. The polymeric composition of claim 1, wherein the flame retardant comprises a flame retardant obtained from a renewable source.

11. The polymeric composition of claim 10, wherein the flame retardant is a non-halogenated phosphorus containing flame retardant obtained from bio-based chemicals.

12. The polymeric composition of claim 1, wherein the post-consumer recycled ITE waste derived PC/ABS blend comprises additives.

13. The polymeric composition of claim 1, further comprising an additive, wherein the additive is a pigment, a plasticizer, an antioxidant, an UV-stabilizer, a heat stabilizer, a dye enhancing agent, a lubricant, a mold release agent, a crystal nucleating agent, a fluidability-improving agent, an antistatic agent, a compatibilizer, an anti-drip agent, or any combination thereof.

14. The polymeric composition of claim 1, wherein the composition is comprised in a film, a layer, or a sheet.

15. The polymeric composition of claim 1, wherein the composition is an extruded, blow-molded, injection-molded, rotational molded, compression molded, 3-D printed, and/or thermoformed composition.

16. A computer chassis, monitor chassis, and/or computer peripheral chassis comprising the polymeric composition of claim 1.

17. The computer chassis, monitor chassis, and/or computer peripheral chassis of claim 16, wherein the computer chassis is a desktop computer chassis, a laptop computer chassis, or a computer tablet chassis.

18. A method of making a computer chassis, monitor chassis, and/or computer peripheral chassis, the method comprising forming at least a portion of the computer chassis, computer screen chassis, and/or computer peripheral with the polymeric composition of claim 1.

19. The method of claim 18, wherein at least 70 wt. % of the computer chassis, computer screen chassis, and/or computer peripheral chassis, and/or a part thereof, comprises the polymeric composition.

20. The method of claim 18, wherein the polymeric composition further comprises:
non-ITE derived post-consumer recycled resin;
polycarbonate/acrylonitrile butadiene styrene (PC/ABS) virgin blend; and/or
polycarbonate resin derived from a renewable source.
